(19) United States
(12) Patent Application Publication
(10) Pub. No.: US 2024/0248701 A1
(43) Pub. Date: Jul. 25, 2024

(54) FULL STACK IN-PLACE DECLARATIVE UPGRADES OF A KUBERNETES CLUSTER

(71) Applicant: DELL PRODUCTS L.P., Round Rock, TX (US)

(72) Inventors: Vijayasimha Reddy Naga, Georgetown, TX (US); Prasant K. Padhi, Bangalore (IN); Barry A. Feigenbaum, Austin, TX (US)

(21) Appl. No.: 18/158,930

(22) Filed: Jan. 24, 2023

(51) Int. Cl. G06F 8/65

(52) U.S. Cl. CPC G06F 8/65

(57) ABSTRACT

A control node of a cluster includes a storage that stores an upgrade bundle associated with upgrades to worker nodes in the cluster. The worker nodes include first and second worker nodes. A processor receives the upgrade bundle and determines upgrade preferences for the upgrade bundle. The processor further generates an upgrade preview based on the upgrade bundle and the upgrade preferences. Based on the upgrade preview, the processor determines an upgrade schedule for the cluster. Based on the upgrade schedule, the processor performs infrastructure upgrades in the cluster, and performs application upgrades in the cluster.

### FIELD OF THE DISCLOSURE

The present disclosure generally relates to information handling systems, and more particularly relates to full stack in-place declarative upgrades of a kubernetes cluster.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

In previous cluster environments upgrades are for a single host or a single application. In this situation, a user must be very rigid in the way the upgrade is done in the cluster. The user would need to select between different tradeoffs. The tradeoffs for the upgrade process may include performing upgrades in parallel but with some disruptions, performing upgrades in serial but not disruptive, performing upgrades all at once or split across maintenance windows, or the like.

### SUMMARY

A control node of a cluster includes a storage that may store an upgrade bundle associated with upgrades to worker nodes in the cluster. The worker nodes include first and second worker nodes. A processor may receive the upgrade bundle and determine upgrade preferences for the upgrade bundle. The processor further may generate an upgrade preview based on the upgrade bundle and the upgrade preferences. Based on the upgrade preview, the processor may determine an upgrade schedule for the cluster. Based on the upgrade schedule, the processor may perform infrastructure upgrades in the cluster, and perform application upgrades in the cluster.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a multiple node environment according to at least one embodiment of the present disclosure;

FIG. 2 is a diagram of an upgrade bundle layout according to at least one embodiment of the present disclosure;

FIG. 3 is a diagram of a manifest definition portion of an upgrade bundle according to at least one embodiment of the present disclosure;

FIG. 4 is a diagram of upgrade preferences for the upgrade bundle according to at least one embodiment of the present disclosure;

FIG. 5 is a flow diagram of a method for performing upgrades in a Kubernetes cluster according to at least one embodiment of the present disclosure; and

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

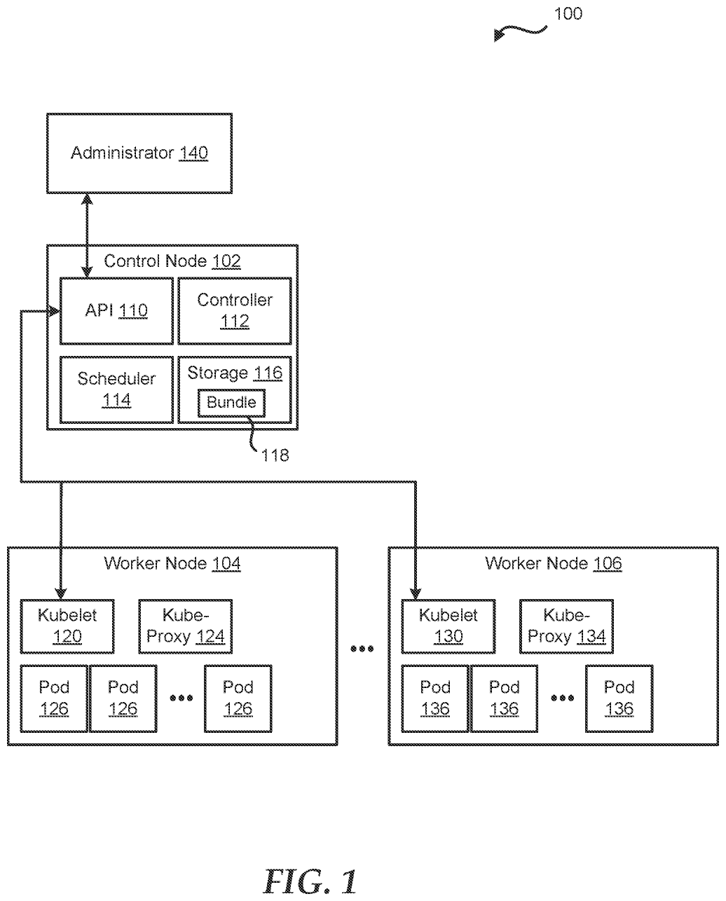

FIG. 1 illustrates a multiple node environment 100 according to at least one embodiment of the present disclosure. Multiple node environment 100 includes a control node 102, and worker nodes 104 and 106. Control node 102 includes an application program interface (API) 110, a controller 112, a scheduler 114, and a storage 116. In an example, controller 112 may be any suitable processor or controller, such as a life cycle controller (LCC). Control node 108 may include LCC 112 while in a bare metal state. Storage 116 may store any suitable data associated with nodes 104 and 106, such as an update bundle 118. Worker node 104 includes a kubelet 120, a Kube-proxy 124, and multiple pods 126. Worker node 106 includes a kubelet 130, a Kube-proxy 134, and multiple pods 136. In an example, multiple node environment 100 may be any suitable environment including but not limited to a kubernetes cluster. Multiple environment 100 may be a cloud system with one or more bare metal servers, such as worker nodes 104 and 106.

In certain examples, multiple node environment 100 may include any suitable number of worker nodes as illustrated by the ellipses between worker nodes 104 and 106. For example, the Kubernetes cluster of multiple node environment 100 may operation on worker nodes 104 and 106, on three worker nodes, on five worker nodes, or the like. In certain examples, control node 108 may include a vertical operation stack may be implemented across multiple servers, such as worker nodes 104 and 106. In an example, operations and features of the components in worker nodes 104 and 106, such as kubelets 120 and 130, Kube-proxies 124 and 134, and pods 126 and 136, are known in art and will not be further disclosed herein, except as needed to illustrate the various embodiments disclosed herein. Control node 102, and worker nodes 104 and 106 may include additional or fewer components without varying from the scope of this disclosure.

In addition, connections between components may be omitted for descriptive clarity. In certain examples, clusters, such as multiple node environment 100, may be flat, hierarchical/distributed, or the like. Flat clusters may include all hosts/nodes on a common structure, such as a switch. Hierarchical or distributed clusters may include hosts/nodes in different geographical locations, different switches/sub nets, different racks, or the like. In an example, the cluster may include any number of control nodes 102, and these control nodes may also be worker nodes. In this example, movement of applications, such as via Kubernetes services, between nodes to keep the control functionality working as control node(s) 102 are updated. In certain examples, at least one control node 102 may be replicated to enable the control nodes to continue to work during upgrades.

In certain examples, pods 126 and 136 may be the smallest deployable units of computing that may be created and managed in Kubernetes clusters. Pods 126 may be a group of one or more containers within worker node 104, with shared storage and network resources, and a specification for how to run the containers. Similarly, nodes 136 may be a group of one or more containers within worker node 106, with shared storage and network resources, and a specification for how to run the containers. In an example, the contents of pods 126 and 136 may be co-located, d co-scheduled and run in a shared context. In certain examples, worker nodes 104 and 106 may be bare metal information handling systems with one or more pods 126 and 136. In an example, pods 126 and 136 may be application-specific logical host that contain one or more application containers which are relatively tightly coupled. In non-cloud contexts, applications executed on the same physical or virtual machine may be analogous to cloud applications executed on the same logical host. In an example, pods 126 and 136 may include initialization containers that run during startup of the pods.

In previous Kubernetes clusters, the infrastructure upgrades and application upgrades may be managed separately. In these previous clusters, an individual associated with the cluster may need to understand the dependencies between the components in the different layers to perform the upgrade processes manually.

A manual update process may cause the entire process to be very complicated. Additionally, the complexity of the update may be further increase by several constraints, such as limited maintenance windows. In previous cluster, the individual may need to further break down the upgrade or update into smaller portions so that the upgrade may be done in parts. Control node 102 and worker nodes 104 and 106 may be improved by the control node performing the infrastructure and application upgrades in a completely automated manner without user interaction beyond the uploading of the upgrade bundle. For example, control node 102 may provide an integrated solution for upgrading an entire stack using Kubernetes native declarative operations.

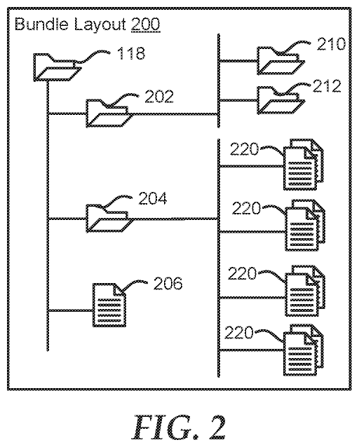

In this example, an administrator 140 provide upgrade bundle 118 to control node 102 via declarative API 110, and controller 112 in control node 102 may automate and abstract the complexities involved in the upgrade process. In an example, administrator 140 may create a bundle structure or layout 200 as illustrated in FIG. 2.

FIG. 2 illustrates upgrade bundle layout 200 according to at least one embodiment of the present disclosure. Upgrade bundle layout 200 includes a digital data folder for upgrade bundle 118. Within digital data folder for upgrade bundle 118, bundle layout 200 includes a digital data sub-folder infrastructure 202, digital data sub-folder applications 204, and a manifest document 206. In an example, manifest document 206 may be any suitable computer file including, but not limited to, a JavaScript Object Notation (JSON) file.

In an example, infrastructure folder 202 may include any suitable number of additional sub-folders including, but not limited to, an OS/FW artifacts folder 210 and a Kubernetes artifacts folder 212. In certain examples, controller 112 in control node 102 of FIG. 1 may utilize the data within OS/FW artifacts folder 210, Kubernetes artifacts folder 212, and application upgrade artifacts during the upgrade operations. In an example, OS/FW artifacts folder 210 and Kubernetes artifacts folder 212 may include any suitable data associated with worker nodes 104 and 106 of FIG. 1, such as current states of pods 126 and 136 or the like. Application folder 206 may include any suitable number of data files 220. In an example, data files 220 may associated with applications on worker nodes 104 and 106 of FIG. 2, such as charts and images for the applications.

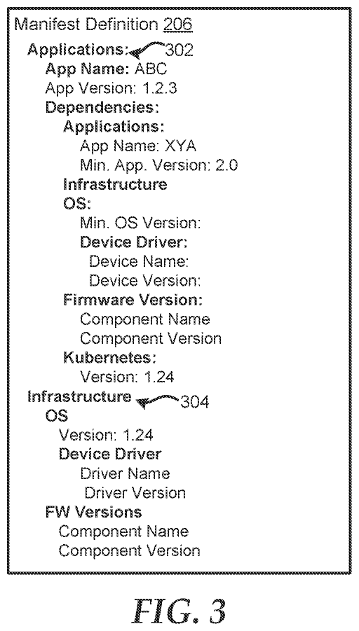

FIG. 3 illustrates manifest definition portion 302 of upgrade bundle 118 according to at least one embodiment of the present disclosure. Manifest definition 302 may be utilized by processor/controller 112 in the control node 102 to define current states for applications 302 and infrastructure 304 of each of worker nodes 104 and 106 in FIG. 1. While applications 302 may include one or more applications executed on a worker node, for clarity and brevity manifest definition portion 302 will be described with respect to a single application.

Applications 302 may include any suitable metadata values, such as an application name, a corresponding application number, special conditions needed for an upgrade, or the like, for the application being executed in the cluster, such as the cluster formed by worker nodes 104 and 106 of FIG. 1. In an example, applications portion 302 of manifest definition 206 may include any corresponding dependencies for each application of the Kubernetes cluster. In this example, the dependencies may include applications or infrastructure needed to enable the application to execute. For example, applications portion 302 may include application names and application versions for each application that a particular application depends on. In certain examples, applications portion 302 may also includes infrastructure dependencies for an application. The infrastructure dependencies for an application may include a minimum OS version, and one or more device drivers with a device name and driver version. The infrastructure dependencies may also include firmware versions, such as component names and versions, and a Kubernetes version for the infrastructure.

Infrastructure portion 304 of manifest definitions 206 may include any suitable data associated with the infrastructure of the cluster including, but not limited to, control node 102 and worker nodes 104 and 106 of FIG. 1. Infrastructure portion 304 includes a current OS version and one or more current device drivers for the infrastructure. The current device drivers section may include different device names and version for the devices of the infrastructure. Infrastructure portion 304 may also include firmware versions, such as component names and versions, for the infrastructure of the cluster.

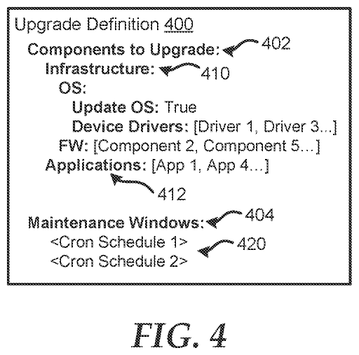

FIG. 4 illustrates upgrade preferences 400 for upgrade bundle 118 according to at least one embodiment of the present disclosure. Upgrade preferences 400 includes a list of components to upgrade 402 and maintenance windows 404. In an example, components to upgrade 402 may include a corresponding infrastructure 410 and applications 412 for each component. In an example, the infrastructure portion 410 includes an identification of an OS, whether to update the OS, and device drivers within the OS. For example, the update OS field may be a flag set to true or false for whether the OS is to be updated. The device drivers field may include a list of device drivers within infrastructure 410 associated with the OS. Additionally, infrastructure section 410 may include firmware associated with different components, such as component 1 and component 2, for the infrastructure of the cluster. In an example, user preferences 400 may be provide to control node 102 via any suitable manner including, but not limited to, within manifest 206, within additions to a process that launches the upgrade or global system state values.

In an example, applications section 412 may list different applications to be upgrades within components to upgrade 402. For example, applications section 412 may include, but is not limited to, application 1, application 4, and application 5. In certain examples, maintenance windows 404 may include one or more times or schedules 420 when the upgrade may be performed. For example, one schedule 420 of maintenance window 404 may indicate that the upgrades may be performed during off peak times of the cluster during weekdays. Another schedule 420 of maintenance window 404 may indicate that the upgrades may be performed during weekends.

Referring back to FIG. 1, administrator 140 may communicate with control node 108 through any suitable manner, such as via API 110. In an example, administrator 140 may upload upgrade bundle 118 to control node 108 via API 110. In response to upgrade bundle 118 being received in control node 108, the upgrade bundle may be stored in storage 116. As stated above, upgrade bundle 118 may include manifest definition 206 as described above with respect to FIG. 3 and upgrade definition 400 as described above with respect to FIG. 4. In an example, controller or processor 112 may utilize manifest 206 to determine the dependencies of the components in the cluster across different layers and worker nodes 104 and 106. Based on manifest 206, processor 112 may perform an automated upgrade process for the cluster, such as multiple node environment 100.

Controller 112 may break down or separate the overall upgrade bundle 118 into different plans or operations that may be executed independent from the other portions. In an example, the separating of upgrade bundle 119 into different parts may enable controller 112 to leave the cluster in an operational state while each of the partial upgrades are performed. In certain examples, processor 112 may further utilize manifest 206 and user preferences 400 to determine or calculate a schedule for the upgrades with minimum/acceptable disruption to the workload in the cluster or multiple node environment 100. Controller 112 may determine what updates may be able to be performed in parallel, such that a minimum possible amount of time is used to complete the entire upgrade bundle 118.

In certain examples, the updates or upgrades may be performed all worker nodes, such as worker nodes 104 and 106, for only selected worker nodes, or the like. In an example, the selection of worker nodes may be by a user input or attributes of hosts. For example, the selection may be to upgrade on control nodes 102, only worker nodes 104 and 106, only hosts/nodes with database applications, or the like. In certain examples, during an upgrade control node/host 102 may be treated as a member of the worker node host set. In an example, the main difference is that control host 102 executes Kubernetes services and worker nodes 104 and 106 generally do not execute these services. In this situation, all hosts/nodes in cluster 100 may be a control host if that node executers Kubernetes services.

In an example, controller 112 may utilize user preferences 400 to enable administrator 140 schedule partial upgrades as required. For example, the partial upgrades may include, but are not limited to, critical infrastructure updates or security patches only, and upgrade specific applications in a certain order. Additionally, controller 112 may ensure that the portions of upgrade bundle 118 fit into the given maintenance windows 404 of preferences 400 in FIG. 4. Upgrade bundle 118 may also include a sequence 420 for the portions of the upgrade based on preferences of administrator 140.

In certain examples, controller 112 may execute a reconciliation loop for upgrade bundle 118. During the execution of the reconciliation loop, controller 112 may continuously retry different iterations of upgrade operations or schedules of upgrades for both infrastructure and applications of the cluster. In an example, processor 112 may provide an integrated solution for upgrading the entire stack using Kubernetes native declarative operations.

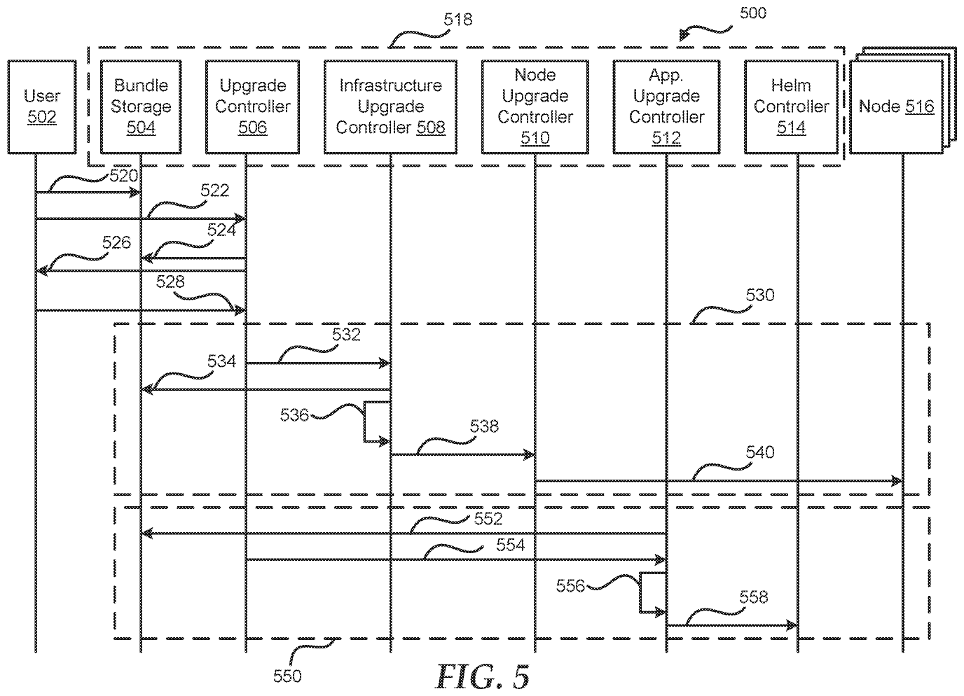

FIG. 5 illustrates a flow of a method 500 for performing upgrades in a Kubernetes cluster according to at least one embodiment of the present disclosure. The operations described with respect to FIG. 5 may be performed by any suitable component including, but not limited to, a user node 502, a bundle storage 504, an upgrade controller 506, an infrastructure upgrade controller 508, a node upgrade controller 510, an application upgrade controller 512, a helm controller 514, and one or more worker nodes 516. In certain examples, bundle storage 504, upgrade controller 506, infrastructure upgrade controller 508, node upgrade controller 510, application upgrade controller 512, and helm controller 514 may be components of a control node 518. Control node 518 may be substantially similar to control node 108 of FIG. 1. In an example, user node may be substantially similar to administrator node 140 of FIG. 1, and worker nodes 516 may be substantially similar to worker nodes 104 and 106 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At operation 520, user node 502 may provide or upload an upgrade bundle to bundle storage 504. In certain examples, bundle storage 504 may be located in the same cluster as the nodes of the cluster. However, in additional examples, bundle storage 504 may be located in a node that is remote from the cluster. In an example, the upgrade package may be provided via an API of control node 518, and a processor of the control node may store the upgrade bundle in bundle storage 504. In certain examples, the upgrade package may include a list of preferences associated with the how the upgrade package may be installed. For example, the list of preferences may include one or more time windows for the upgrade to be performed, a preference of whether an amount of time for the upgrade to be performed or operation of the cluster is more important.

At operation 522, user node 502 provides an upgrade preview request to upgrade controller 506. In an example, the upgrade preview request may be any suitable request associated with the upgrade bundle. For example, the upgrade preview request may be for a sequence of upgrades to be performed, an amount of time associated with the upgrades, an operational level for the cluster during the upgrade operations, or the like.

At operation 524, upgrade controller 506 retrieve a manifest associated with the upgrade bundle from the bundle storage 504. In an example, the manifest may include any suitable data associated with the upgrade including, but not limited to, current states of worker nodes 516 in the cluster, current versions of applications, and preferences for the upgrade. may include any suitable data associated with the infrastructure of the cluster. The manifest may include a current OS version and one or more current device drivers for the infrastructure, different device names and version for the devices, and firmware versions, such as component names and versions, for the infrastructure of the cluster. Based on the manifest, upgrade controller 506 may determine or calculate an upgrade preview. At operation 526, upgrade controller 506 provides the upgrade preview to user node 502.

At operation 528, user node 502 sends a schedule upgrade request to upgrade controller 506. The schedule upgrade request may identify that the cluster upgrade may be performed. In response to the schedule upgrade request, multiple operations may be performed to determine a most efficient manner to perform the infrastructure upgrades of the upgrade bundle as indicated in box 530. In certain examples, the infrastructure upgrades in box 530 may be perform based on upgrade controller analyzing the entire stack of the cluster and performing the upgrade on the entire stack including the bare metal nodes 516. In an example, the infrastructure upgrades within box 530 may be performed in one sequence of operations within a minimum number of disruptions to the cluster. Disruptions to the cluster may include, but are not limited to, a number of reboots in nodes 516. In certain examples, upgrade controller 506 may normalize the reboots across the firmware, OS, and driver upgrades for nodes 516 of the cluster.

At operation 532, upgrade controller 506 provides upgrades for one or more portions of an operating system (OS) in the cluster to infrastructure upgrade controller 508. In an example, the portions of the OS include, but are not limited to, firmware, OS, drivers, and applications directly hosted on the OS. At operation 534, infrastructure upgrade controller 510 retrieves infrastructure update/upgrade artifacts from bundle storage 504. In an example, the infrastructure update/upgrade artifacts may include a current OS version and one or more current device drivers for the infrastructure, different device names and version for the devices of the infrastructure, and firmware versions, such as component names and versions, for the infrastructure of the cluster.

At operation 536, infrastructure upgrade controller 508 determines infrastructure upgrades that may be performed in parallel. In an example, the infrastructure upgrade controller 508 may utilize any suitable data to determine the upgrades that may be performed in parallel. For example, the data may include, but is not limited to, maintenance windows for the update, a number of nodes 516 in the cluster, a number of nodes needed to maintain the desired level of service in the cluster, and whether level or service or upgrade time is more important.

In an example, infrastructure upgrade controller 508 may determine whether an amount of time for the upgrade will extend beyond a single maintenance window. If so, infrastructure upgrade controller 508 may determine whether to perform the upgrades outside of the maintenance window or to pause the upgrade until after a next maintenance window. In certain examples, infrastructure upgrade controller 508 may determine that the cluster includes ten worker nodes 516, and that eight of the worker nodes are needed to not degrade service in the cluster. Based on this determination, infrastructure upgrade controller 508 may upgrade two worker nodes 516 at a time to reduce the upgrade time but not degrade the service of the cluster.

At operation 538, infrastructure upgrade controller 508 provides an infrastructure upgrade schedule to node upgrade controller 510. In an example, the infrastructure upgrade schedule may indicate that an application running on an worker node 516 may be moved to another worker node so that worker node may be upgraded. Additionally, infrastructure upgrade controller 508 may determine a number of nodes 516 to remain operational to keep the cluster below a failure level. At operation 540, node upgrade controller 510 performs upgrades on the infrastructure of nodes 516 based on the infrastructure upgrade schedule.

In response to the schedule upgrade request, multiple operations may be performed to determine a most efficient manner to perform the application upgrades of the upgrade bundle as indicated in box 550. In an example, the application upgrades may be rolling and non-disruptive to the operation of the cluster. For example, the application upgrades may be performed in a manner that a minimum level of operation in nodes 516 may continue during the application upgrades. In certain examples, the application upgrades within box 550 may be performed in parallel with the infrastructure upgrades within box 530. In other examples, the application upgrades within box 550 may be before or after the infrastructure upgrades within box 530.

At operation 552, application upgrade controller 512 retrieves application update/upgrade artifacts from bundle storage 504. The application artifacts may indicate a current state or version of the applications to be upgraded. In certain examples, the application upgrades may be cluster oriented and not simply node by node oriented.

At operation 554, upgrade controller 506 provides upgrades for applications in the cluster to application upgrade controller 512. At operation 556, application upgrade controller 512 applies sequential application updates. At operation 558, application upgrade controller 512 retrieves a helm chart from helm controller 514. In an example, helm controller 514 may be a component that is internal to control node 518, as shown in FIG. 5, or a component that is external to the control node without varying from the scope of this disclosure. During the upgrade operations, user node 502 may communicate with upgrade controller 506 to receive snapshots of how the upgrade is progressing.

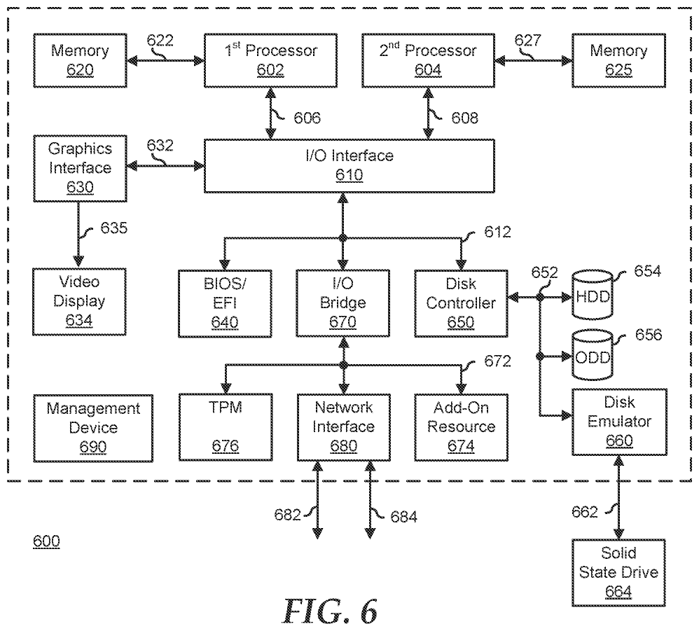

FIG. 6 shows a generalized embodiment of an information handling system 600 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 662, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 662, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 6394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A control node of a cluster, the control node comprising:
a storage configured to store an upgrade bundle, wherein the upgrade bundle is associated with upgrades to a plurality of worker nodes in the cluster, wherein the worker nodes include first and second worker nodes; and
a processor to communicate with the storage, the processor to:
receive the upgrade bundle;
determine a plurality of upgrade preferences for the upgrade bundle;
based on the upgrade bundle and the upgrade preferences, determine an upgrade schedule for the cluster; and
based on the upgrade schedule, the processor to:
perform infrastructure upgrades in the cluster; and
perform application upgrades in the cluster.

2. The control node of claim 1, wherein the upgrade preferences include one or more maintenance windows, wherein each maintenance window identifies a time period when the cluster upgrade may be performed.

3. The control node of claim 1, wherein the upgrade preferences indicates that performance of operations within the cluster is a higher priority than a length of time for the cluster upgrade to be performed.

4. The control node of claim 1, wherein the performance of the infrastructure upgrades, the processor further to:
retrieve infrastructure upgrade artifacts from the upgrade bundle;
based on the user preferences and the infrastructure upgrade artifacts, determine a sequence of nodes to upgrade; and
perform the upgrade on the nodes based on the sequence of nodes.

5. The control node of claim 1, wherein the performance of the infrastructure upgrades, the processor further to: upgrade the first worker node while the second worker node continues to operate within the cluster.

6. The control node of claim 1, wherein the infrastructure upgrades in the cluster are performed an work node-by-work node basis.

7. The control node of claim 1, wherein the application upgrades in the cluster are performed on all the work nodes of the cluster at a same time.

8. The control node of claim 1, wherein the processor further to:
generate an upgrade preview based on the upgrade bundle and the upgrade preferences.

9. A method comprising:
receiving, at a processor in a control node of a cluster, an upgrade bundle, wherein the upgrade bundle is associated with a plurality of worker nodes of the cluster, wherein the worker nodes include first and second worker nodes;
determining a plurality of upgrade preferences for the upgrade bundle;
based on the upgrade bundle and the upgrade preferences, determining an upgrade schedule for the cluster; and
based on the upgrade schedule:
performing infrastructure upgrades in the cluster; and
performing application upgrades in the cluster.

10. The method of claim 9, wherein the upgrade preferences include one or more maintenance windows, wherein each maintenance window identifies a time period when the cluster upgrade may be performed.

11. The method of claim 9, wherein the upgrade preferences indicates that performance of operations within the cluster is a higher priority than a length of time for the cluster upgrade to be performed.

12. The method of claim 9, wherein the performance of the infrastructure upgrades, the method further comprises:
retrieving infrastructure artifacts from the upgrade bundle;
based on the user preferences and the infrastructure artifacts, determining a sequence of nodes to upgrade; and
performing the infrastructure upgrades on the nodes based on the sequence of nodes.

13. The method of claim 9, wherein the performing of the infrastructure upgrades, the method further comprises: upgrading the first worker node while the second worker node continues to operate within the cluster.

14. The method of claim 9, wherein the infrastructure upgrades in the cluster are performed an work node-by-work node basis.

15. The method of claim 9, wherein the application upgrades in the cluster are performed on all the work nodes of the cluster at a same time.

16. The method of claim 9, further comprising: generating an upgrade preview based on the upgrade bundle and the upgrade preferences.

17. A method comprising:
receiving, at a processor in a control node of a cluster, an upgrade bundle, wherein the upgrade bundle is associated with a plurality of worker nodes of the cluster, wherein the worker nodes include first and second worker nodes;
determining a plurality of upgrade preferences for the upgrade bundle;
generating, by the processor in the control node of the cluster, an upgrade preview based on the upgrade bundle and the upgrade preferences;
based on the upgrade preview, determining an upgrade schedule for the cluster; and
based on the upgrade schedule:
retrieving infrastructure artifacts from the upgrade bundle;
based on the user preferences and the infrastructure artifacts, determining a sequence of nodes to upgrade;
performing infrastructure upgrades on the nodes based on the sequence of nodes;
retrieving application artifacts from the upgrade bundle;
based on the user preferences and the application artifacts, determining application upgrades; and
performing the application upgrades on the cluster.

18. The method of claim 17, wherein the performing of the infrastructure upgrades, the method further comprises: upgrading the first worker node while the second worker node continues to operate within the cluster.

19. The method of claim 17, wherein the infrastructure upgrades in the cluster are performed an work node-by-work node basis.

20. The method of claim 17, wherein the application upgrades in the cluster are performed on all the work nodes of the cluster at a same time.
